(19) United States
(12) Patent Application Publication
(10) Pub. No.: US 2017/0083816 A1
(43) Pub. Date: Mar. 23, 2017

(54) SYNTHETIC COGNITIVE STATES BASED ON SYNTHETIC EVENTS FROM MEASURED DATA

(71) Applicant: International Business Machines Corporation, Armonk, NY (US)

(72) Inventors: Robert R. FRIEDLANDER, Southbury, CT (US); James R. KRAEMER, Santa Fe, NM (US)

(21) Appl. No.: 14/862,769

(22) Filed: Sep. 23, 2015

(51) Int. Cl. G06N 5/02

(52) U.S. Cl. CPC G06N 5/022

(57) ABSTRACT

Generating synthetic emotional cognitive states based on generating synthetic events. The synthetic event is based on accessing a first set of data measurements from physical sensors related to a user. The data measurements are processed to generate one or more synthetic events. Each of the synthetic events comprise a second set of data representing a result of a mathematical computation defined by an operation S(p1)==>F(p2). S is the first set of one or more data measurements with probability p1. F is an inferred event with probability p2, and each of the synthetic events is a particular set of data that represents, encodes, or records at least one of a thing or happening. The synthetic events are processed to denote one or more synthetic emotional cognitive states of a user has been reached. The synthetic emotional cognitive states comprise a third set of data representing a result of a mathematical computation defined by an operation S′(p1′)==>F′(p2′).

### BACKGROUND

The invention relates generally to predicting a cognitive state of a user, and more particularly to building synthetic events from measured data sources, such as sensors, and processing these synthetic events to denote a synthetic cognitive state.

The is currently no efficient and effective to go from various sensor inputs and at various levels and combine them into labelled, repeatable and definable events. Next take those events and convert them into cognitive units and then convert the cognitive units into actions through human or computer activation.

### SUMMARY

Disclosed is a computer program product, system and computer-implemented method to map synthetic events, such as subject blink rate, subject respiration rate, room temperature, ambient noise level, etc., to synthetic cognitive events. The synthetic cognitive events are frame of mind, state of mind, mental focus, state of awareness, may reflect a physical need or desire. The synthetic cognitive events may be further evaluated based on rule sets to trigger computer or human driven actions.

In one example, the computer program product, system and computer-implemented method generates synthetic emotional cognitive states based on generating synthetic events. The synthetic event is based on accessing a first set of data measurements from physical sensors related to a user. The data measurements are processed to generate one or more synthetic events. Each of the synthetic events comprise a second set of data representing a result of a mathematical computation defined by an operation S(p1)==>F(p2). S is the first set of one or more data measurements with probability p1. F is an inferred event with probability p2, and each of the synthetic events is a particular set of data that represents, encodes, or records at least one of a thing or happening. The synthetic events are processed to denote one or more synthetic emotional cognitive states of a user has been reached. The synthetic emotional cognitive states comprise a third set of data representing a result of a mathematical computation defined by an operation S′(p1′)==>F′(p2′). S′ is the second set of the one or more synthetic events with probability p1′. F′ is an inferred event with probability p2′.

The details of the preferred embodiments of the invention, both as to its structure and operation, are described below in the Detailed Description section in reference to the accompanying drawings. The Summary is intended to identify key features of the claimed subject matter, but it is not intended to be used to limit the scope of the claimed subject matter.

### BRIEF DESCRIPTION OF THE DRAWINGS

The accompanying figures wherein reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a pictorial representation of a data processing system in which an illustrative embodiment may be implemented;

FIG. 2 is a block diagram of a data processing system in which an illustrative embodiment may be implemented;

FIG. 3 is a block diagram illustrating a combination of synthetic events, in accordance with an illustrative embodiment;

FIG. 4 is a block diagram illustrating processing of events in a processor having multi-threading processing capability, in accordance with an illustrative embodiment;

FIG. 5 is a flowchart of a process for generating synthetic events, in accordance with an illustrative embodiment; and

FIG. 6 is a block diagram illustrating a combination of synthetic emotional cognitive events, in accordance with an illustrative embodiment; and

FIG. 7 is a block diagram illustrating a combination of synthetic emotional cognitive events, in accordance with an illustrative embodiment.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention probabilistically detects external stimulus and map the stimulus to one or more synthetic events and then to probabilistically map the synthetic events to one or more synthetic cognitive units and then based on rule sets trigger action either human or computer based

### NON-LIMITING DEFINITIONS

The terms “a”, “an” and “the” are intended to include the plural forms as well, unless the context clearly indicates otherwise.

The terms “comprises” and/or “comprising”, when used in this specification, specify the presence of stated features, steps, operations, elements, and/or components, but do not preclude the presence or addition of one or more other features, integers, steps, operations, elements, components, and/or groups thereof.

The term “inferred artifact” is used to mean state of mind, mental focus, state of awareness, may reflect a physical need or desire. This artifact may or may not be directly mappable to the “real world”.

The term “synthetic event” and “synthetic cognitive event states” are artificial constructs used to model and process real world stimulus, states, and actions. They may or may not be directly mappable to real world events. Synthetic Events and Synthetic Cognitive Event States are probabilistic constructs with probabilities of −1.0 to 1.0

The phrase “synthetic emotional cognitive state” or “synthetic state of mind” is an artificial probabilistic construct of a person's mood and the effect that mood has on the person's thinking and behavior at a certain time; the condition or character of a person's thoughts or feelings. The “synthetic emotional cognitive state” may represent a mental focus, state of awareness, or may reflect a person's physical need or desire. Examples of mental states are questioning, fear, anxiety, and happiness.

### Data Processing System

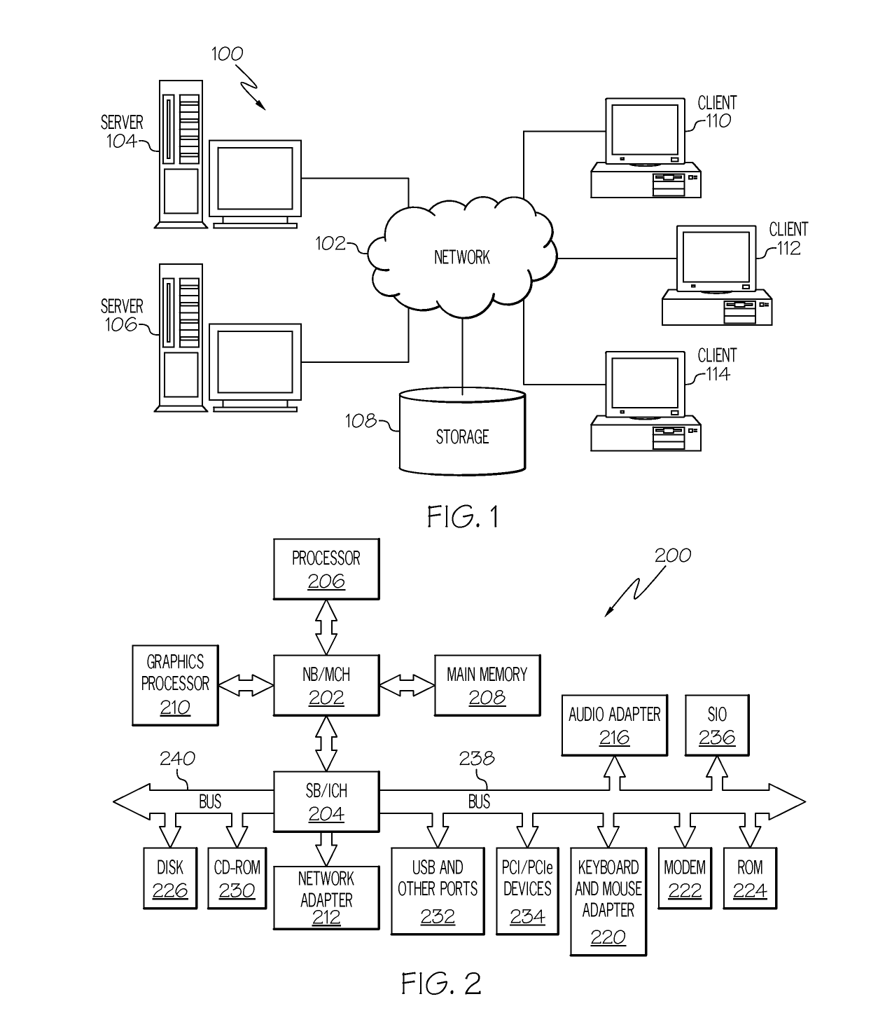

With reference now to the figures, FIG. 1 depicts a pictorial representation of a network of data processing systems in which an illustrative example may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which an illustrative embodiment may be implemented. Data processing system 200 is an example of a computer, such as server 104 or client 110 in FIG. 1, in which computer usable code or instructions implementing the processes may be located for the different embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 230, modem 232, read only memory (ROM) 234, universal serial bus (USB) ports and other communications ports 242, and PCI/PCIe devices 244 are coupled to south bridge and I/O controller hub 204 through bus 248, and hard disk drive (HDD) 236 and CD-ROM drive 240 are coupled to south bridge and I/O controller hub 204 through bus 240. PCI/PCIe devices may include, for example, Ethernet adapters, add-in cards, and PC cards for notebook computers. P CI uses a card bus controller, while PCIe does not. ROM 234 may be, for example, a flash binary input/output system (BIOS). Hard disk drive 236 and CD-ROM drive 240 may use, for example, an integrated drive electronics (IDE) or serial advanced technology attachment (SATA) interface. A super I/O (SIO) device 246 may be coupled to south bridge and I/O controller hub 204.

An operating system runs on processor 206 and coordinates and provides control of various components within data processing system 200 in FIG. 2. The operating system may be a commercially available operating system such as Microsoft Windows. An object oriented programming system, such as the Java programming system, may run in conjunction with the operating system and provides calls to the operating system from Java programs or applications executing on data processing system 200.

Instructions for the operating system, the object-oriented programming system, and applications or programs are located on storage devices, such as hard disk drive 236, and may be loaded into main memory 208 for execution by processor 206. The processes of the illustrative embodiments may be performed by processor 206 using computer implemented instructions, which may be located in a memory such as, for example, main memory 208, read only memory 234, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

### Synthetic Event

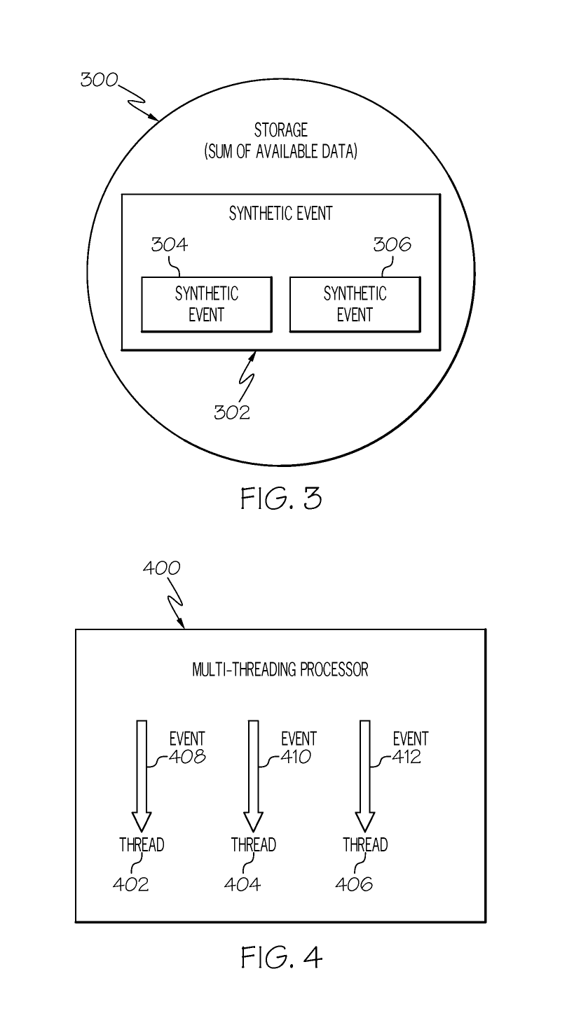

FIG. 3 is a block diagram illustrating a combination of synthetic events, in accordance with an illustrative embodiment. Storage 300 represents the storage devices that contain the sum of available data. The techniques described for creating synthetic events are described in U.S. Pat. No. 8,145,582, entitled “Synthetic Events for Real Time Patient Analysis” the teaching of which is hereby incorporated by reference in its entirety.

The process shown in FIG. 3 can be implemented using one or more data processing systems, including but not limited to computing grids, server computers, client computers, network data processing system 100 in FIG. 1, and one or more data processing systems, such as data processing system 200 shown in FIG. 2. Together, devices and software for implementing the process shown in FIG. 3 can be referred-to as a system.

The term datum is defined as a single fact represented in a mathematical manner, usually as a binary number. A datum could be one or more bytes. Events can be processed by computers by processing objects that represent the events. An event object is a set of data arranged into a data structure, such as a vector, row, cube, or some other data structure. A given activity may be represented by more than one event object. Each event object might record different attributes of the activity. Non-limiting examples of events include purchase orders, email confirmation of an airline reservation, a stock tick message that reports a stock trade, a message that reports an RFID sensor reading, a medical insurance claim, a healthcare record of a patient, a video recording of a crime, and many, many other examples.

An example of an analysis is the generation of generate synthetic event 304 according to the formula S(p1)==>F(p2). As more synthetic events are generated, user feedback provided, and as additional raw data become available, the analysis process can be iterated many times until a reliable and accurate answer is achieved. As a result, a truly vast amount of data can be analyzed to find conclusions and reasons for why the conclusions are true or false. The conclusions can be extremely specific, even down to the individual person or user.

FIG. 3 shows that synthetic events can be generated individually or by combining other synthetic events. Thus, based on storage 300, synthetic event 302 can be generated by combining and/or analyzing synthetic event 304 and synthetic event 306. The resulting synthetic event 302 is reported and then stored for future analysis.

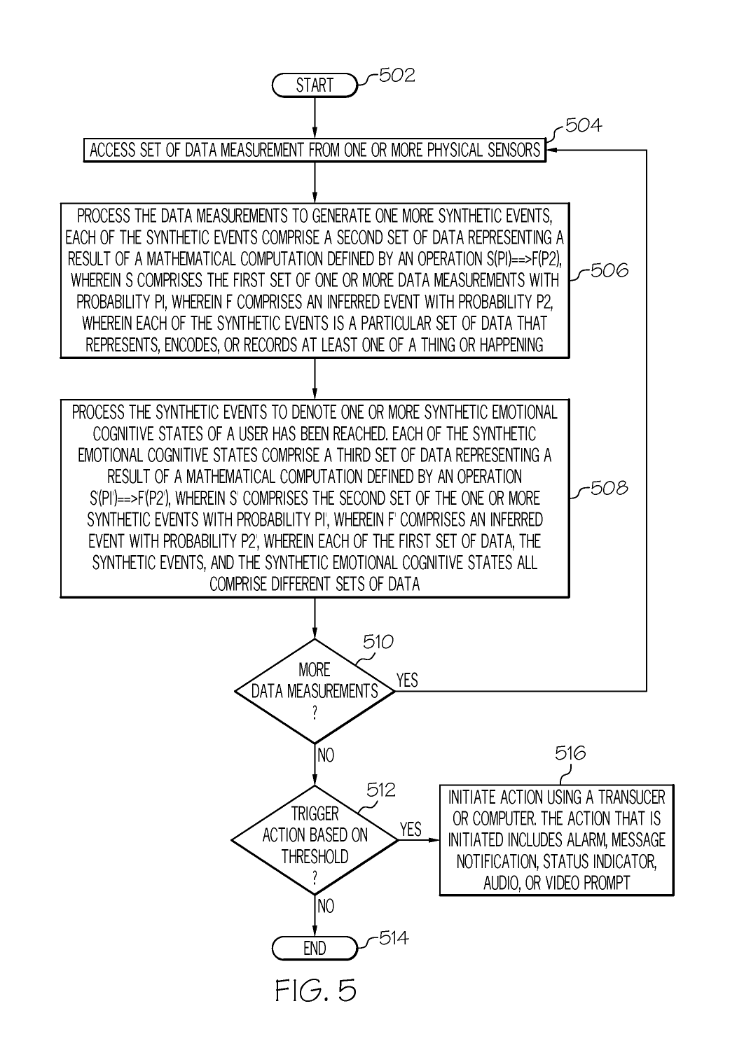

FIG. 4 is a block diagram illustrating processing of events in a processor having multi-threading processing capability, in accordance with an illustrative embodiment. Processor 400 can be processor 200 shown in FIG. 2, or can be one or more processors acting together to provide multi-threading functionality. Multi-threading functionality is often provided by parallel-processing processors.

Processor 400 can be used to more quickly perform synthetic event analysis, as described with respect to FIG. 3. Specifically, each thread, thread 402, thread 404, and thread 406 processes a corresponding distinct event. Thus, thread 402 processes event 408, thread 404 processes event 410, and thread 406 processes event 412. Because each event is processed by a different thread, the entire process of performing analysis is increased. Further, as events are combined into broader events, the number of threads operating can be decreased. Still further, two or more threads could process different aspects of a single event, thereby further increasing the speed of processing.

A synthetic event is defined above is as an even that represents a probability of a future fact or happening, or that represents a probability that a potential past fact or happening has occurred, or that represents a probability that a potential current fact or happening is occurring, with the mathematical formulation of a synthetic event represented by the operation S(p1)==>F(p2), where S is the set of input facts with probability p1 that potentiates future event F with probability p2. Note that future event F in this operation can represent represents a probability that a potential past fact or happening has occurred, or that represents a probability that a potential current fact or happening is occurring, because these probabilities did not exist before a request to calculate them was formulated. Additionally, a synthetic event can be considered a recordable, definable, addressable data interrelationship in solution space, wherein the interrelationship is represented with a surrogate key, and wherein the synthetic event is able to interact with other events or facts for purposes of computer-assisted analysis.

Synthetic events are composed of physically or logically observable events, not suppositions about mental state, unless they can be supported by or characterized as observable fact or numbers. Synthetic events can be compared to generate additional synthetic evens. For example, a previously derived synthetic event is a conclusion that business “B” appears to be entering a market area with probability p1. A second previously derived synthetic event is that, within probability p2, an unknown company is engaging in a large scale hiring of personnel with skill necessary to compete with a particular product line. These two synthetic events can be compared and processed to derive a probability, p3, that business “B” intends to enter into business competition with the particular product line. Other events or synthetic events could be added or combined to the first two previous synthetic events to modify the probability p3.

FIG. 5 is a flowchart of a process for generating synthetic events, in accordance with an illustrative embodiment. The process shown in FIG. 5 represents a process performed to calculate a synthetic event, such as the synthetic events shown in FIG. 3.

The process begins in step 502 and immediately proceeds to step 504 in which the system accesses a set of data measurement from one or more physical sensors related to a user. In step 506, the system processes the data measurements to generate one or more synthetic events. Each of the synthetic events comprise a second set of data representing a result of a mathematical computation defined by an operation S(p1)==>F(p2), wherein S comprises the first set of data measurements with probability p1. The F comprises an inferred event with probability p2, wherein each of the synthetic events is a particular set of data that represents, encodes, or records at least one of a thing or happening.

Next in step 508, the synthetic events in step 504, are processed to denote one or more synthetic emotional cognitive states of a user has been reached. Each of the synthetic emotional cognitive states comprise a third set of data representing a result of a mathematical computation defined by an operation S′(p1′)==>F′(p2′), wherein S′ comprises the second set of the one or more synthetic events with probability p1′. The F′ comprises an inferred event with probability p2′, wherein each of the first set of data, the synthetic events, and the synthetic emotional cognitive states all comprise different sets of data.

In step 510, a test is made to review if more data measurements are available for processing. If there is more data to process, the flow returns to step 504. Otherwise, in step 512 another test is made to see if the synthetic emotional cognitive state is above a settable threshold. In the event it is not the process may terminate in step 514. Otherwise, in the case the threshold is reached, in step 516, an action is initiated using a transducer or computer. The action that is initiated includes an alarm, message notification, status indicator, audio or video prompt.

### Synthetic Emotional Cognitive State

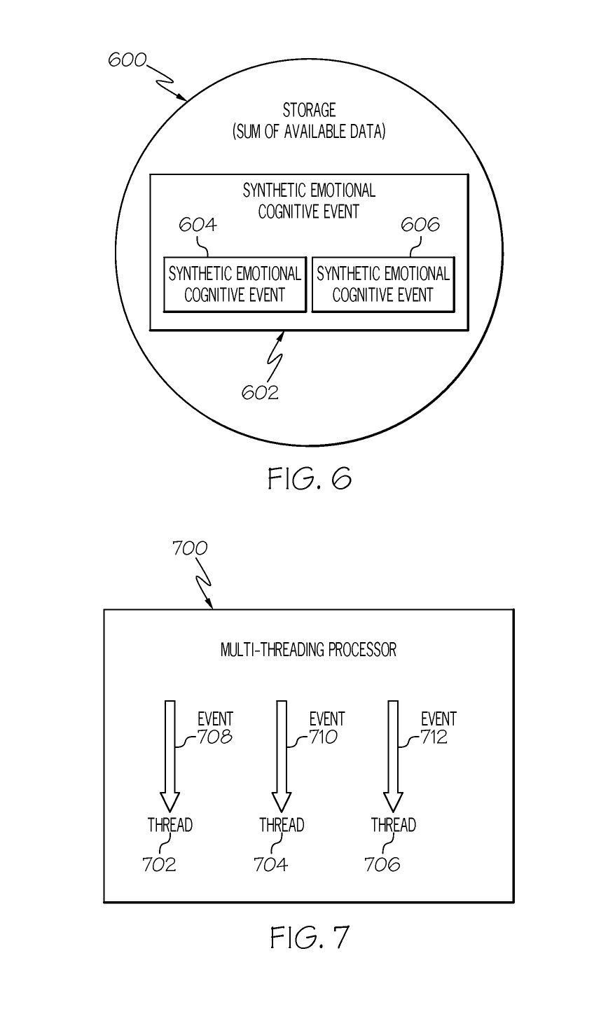

FIG. 6 is a block diagram illustrating a combination of synthetic emotional cognitive events, in accordance with an illustrative embodiment. Storage 600 represents the storage devices that contain the sum of available synthetic emotional cognitive events. The process shown in FIG. 6 can be implemented using one or more data processing systems, including but not limited to computing grids, server computers, client computers, network data processing system 100 in FIG. 1, and one or more data processing systems, such as data processing system 200 shown in FIG. 2.

An example of an analysis is the generation of generate synthetic emotional cognitive state 604 according to the formula S′(p1′)==>F′(p2′). As more Synthetic Emotional Cognitive states are generated, user feedback provided, and as additional raw data become available, the analysis process can be iterated many times until a reliable and accurate answer is achieved. As a result, a truly vast amount of data can be analyzed to find conclusions and reasons for why the conclusions are true or false. The conclusions can be extremely specific, even down to the individual person or user.

FIG. 6 illustrates that synthetic emotional cognitive state events can be generated individually or by combining other synthetic events. Thus, based on storage 600, synthetic emotional cognitive state events 602 can be generated by combining and/or analyzing synthetic emotional cognitive state events 604 and synthetic emotional cognitive state events 606. The resulting synthetic emotional cognitive state events 602 is reported and then stored for future analysis.

FIG. 7 is a block diagram illustrating processing of events in a processor having multi-threading processing capability, in accordance with an illustrative embodiment. Processor 700 can be processor 200 shown in FIG. 2, or can be one or more processors acting together to provide multi-threading functionality. Multi-threading functionality is often provided by parallel-processing processors.

Processor 700 can be used to more quickly perform synthetic emotional cognitive state events analysis, as described with respect to FIG. 6. Specifically, each thread, thread 702, thread 704, and thread 706 processes a corresponding distinct event. Thus, thread 702 processes event 708, thread 704 processes event 710, and thread 706 processes event 712. Because each synthetic emotional cognitive state event is processed by a different thread, the entire process of performing analysis is increased. Further, as events are combined into broader events, the number of threads operating can be decreased. Still further, two or more threads could process different aspects of a single event, thereby further increasing the speed of processing.

A synthetic emotional cognitive state events as defined above, is an “event” that represents a probability of a future fact or happening, or that represents a probability that a potential past fact or happening has occurred, or that represents a probability that a potential current fact or happening is occurring, with the mathematical formulation of a synthetic event represented by the operation S′(p1′)==>F′(p2′), where S is the set of input facts with probability p1 that potentiates future event F with probability p2. Note that future event F in this operation can represent represents a probability that a potential past fact or happening has occurred, or that represents a probability that a potential current fact or happening is occurring, because these probabilities did not exist before a request to calculate them was formulated. Additionally, a synthetic emotional cognitive state event can be considered a recordable, definable, addressable data interrelationship in solution space, wherein the interrelationship is represented with a surrogate key, and wherein the synthetic emotional cognitive state event is able to interact with other events or facts for purposes of computer-assisted analysis.

Synthetic emotional cognitive state events s are composed of physically or logically observable events, not suppositions about mental state, unless they can be supported by or characterized as observable fact or numbers. Synthetic emotional cognitive state events can be compared to generate additional synthetic evens. For example, a previously derived synthetic emotional cognitive state event is a conclusion that user is happy or concerned or frightened.

All steps of this process in FIG. 3 through FIG. 7 are probabilistic Each relationship is assumed to be a many to many Unless otherwise stated each all relationships are not mutually exclusive Each stimulus may go into null to many synthetic events. Each synthetic event may be dispatched to null to many synthetic cognitive units. Each cognitive unit may be used to drive null to many actions based on rule sets.

### Non-Limiting Examples

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The subject matter described above is provided by way of illustration only and should not be construed as limiting. Various modifications and substitutions of the described components and operations can be made by those skilled in the art without departing from the spirit and scope of the present invention defined in the following claims, the scope of which is to be accorded the broadest interpretation so as to encompass such modifications and equivalent structures. As will be appreciated by those skilled in the art, the systems, methods, and procedures described herein can be embodied in a programmable computer, computer executable software, or digital circuitry. The software can be stored on computer readable media or computer program product. For example, computer readable media can include a floppy disk, RAM, ROM, hard disk, removable media, flash memory, a “memory stick”, optical media, magneto-optical media, CD-ROM, etc.

What is claimed is:

1. A computer-implemented method comprising:
accessing a first set of one or more data measurements from one or more physical sensors related to at least one user;
processing the data measurements to generate one or more synthetic events, wherein each of the synthetic events comprise a second set of data representing a result of a mathematical computation defined by an operation S(p1)==>F(p2), wherein S comprises the first set of one or more data measurements with probability p1, wherein F comprises an inferred event with probability p2, wherein each of the synthetic events is a particular set of data that represents, encodes, or records at least one of a thing or happening; and
processing the one or more synthetic events to denote one or more synthetic emotional cognitive states of a user has been reached, wherein each of the synthetic emotional cognitive states comprise a third set of data representing a result of a mathematical computation defined by an operation S′(p1′)==>F′(p2′), wherein S′ comprises the second set of the one or more synthetic events with probability p1′, wherein F′ comprises an inferred event with probability p2′, wherein each of the first set of data, the synthetic events, and the synthetic emotional cognitive states all comprise different sets of data.

2. The computer-implemented method of claim 1, wherein the one or more of the synthetic events are grouped into one or more categories with a sum of each of the synthetic events in a category equal to one.

3. The computer-implemented method of claim 1, wherein the one or more of the synthetic events are distinct events represented by separate processes.

4. The computer-implemented method of claim 1, wherein the one or more of the synthetic events occur within a given time period.

5. The computer-implemented method of claim 1, wherein the processing one or more synthetic events to denote at least one synthetic emotional cognitive state of the user has been reached includes the user's thinking and behavior at a certain time and a condition or character of the user's thoughts or feelings.

6. The computer-implemented method of claim 1, wherein the accessing the first set of one or more data measurements from one or more physical sensors related to the least one user are data measurements of the user's geographical location.

7. The computer-implemented method of claim 1, wherein the accessing the first set of one or more data measurements from one or more physical sensors related to the least one user are data measurements of the user's biomedical data.

8. The computer-implemented method of claim 1, further comprising:
evaluating against a threshold that the at least one synthetic emotional cognitive state of the user has been reached; and
based the threshold being reached, triggering a transducer to take a physical action.

9. A computer program product for computing synthetic emotional cognitive states, the product having a computer readable non-transitory storage medium comprising program code operable for:
accessing a first set of one or more data measurements from one or more physical sensors related to at least one user;
processing the data measurements to generate one or more synthetic events, wherein each of the synthetic events comprise a second set of data representing a result of a mathematical computation defined by an operation S(p1)==>F(p2), wherein S comprises the first set of one or more data measurements with probability p1, wherein F comprises an inferred event with probability p2, wherein each of the synthetic events is a particular set of data that represents, encodes, or records at least one of a thing or happening; and
processing the one or more synthetic events to denote one or more synthetic emotional cognitive states of a user has been reached, wherein each of the synthetic emotional cognitive states comprise a third set of data representing a result of a mathematical computation defined by an operation S′(p1′)==>F′(p2′), wherein S′ comprises the second set of the one or more synthetic events with probability p1′, wherein F′ comprises an inferred event with probability p2′, wherein each of the first set of data, the synthetic events, and the synthetic emotional cognitive states all comprise different sets of data.

10. The computer program product of claim 9, wherein the one or more of the synthetic events are grouped into one or more categories with a sum of each of the synthetic events in a category equal to one.

11. The computer program product of claim 9, wherein the one or more of the synthetic events are distinct events represented by separate processes.

12. The computer program product of claim 9, wherein the one or more of the synthetic events occur within a given time period.

13. The computer program product of claim 9, wherein the processing one or more synthetic events to denote at least one synthetic emotional cognitive state of the user has been reached includes the user's thinking and behavior at a certain time and a condition or character of the user's thoughts or feelings.

14. The computer program product of claim 9, wherein the accessing the first set of one or more data measurements from one or more physical sensors related to the least one user are data measurements of the user's geographical location.

15. The computer program product of claim 9, wherein the accessing the first set of one or more data measurements from one or more physical sensors related to the least one user are data measurements of the user's biomedical data.

16. The computer program product of claim 9, further comprising:
evaluating against a threshold that the at least one synthetic emotional cognitive state of the user has been reached; and
based the threshold being reached, triggering a transducer to take a physical action.

17. A data processing system comprising:
a bus;
a processor connected to the bus;
a memory connected to the bus, the memory storing instructions for carrying out a computer implemented method, wherein the processor is capable of carrying out the instructions of:
accessing a first set of one or more data measurements from one or more physical sensors related to at least one user;
processing the data measurements to generate one or more synthetic events, wherein each of the synthetic events comprise a second set of data representing a result of a mathematical computation defined by an operation S(p1)==>F(p2), wherein S comprises the first set of one or more data measurements with probability p1, wherein F comprises an inferred event with probability p2, wherein each of the synthetic events is a particular set of data that represents, encodes, or records at least one of a thing or happening; and
processing the one or more synthetic events to denote one or more synthetic emotional cognitive states of a user has been reached, wherein each of the synthetic emotional cognitive states comprise a third set of data representing a result of a mathematical computation defined by an operation S′(p1′)==>F′(p2′), wherein S′ comprises the second set of the one or more synthetic events with probability p1′, wherein F′ comprises an inferred event with probability p2′, wherein each of the first set of data, the synthetic events, and the synthetic emotional cognitive states all comprise different sets of data.

18. The data processing system of claim 17, wherein the one or more of the synthetic events are grouped into one or more categories with a sum of each of the synthetic events in a category equal to one.

19. The data processing system of claim 17, wherein the one or more of the synthetic events are distinct events represented by separate processes.

20. The data processing system of claim 17, wherein the one or more of the synthetic events occur within a given time period.
